(19) United States
(12) Patent Application Publication
(10) Pub. No.: US 2007/0282467 A1
(43) Pub. Date: Dec. 6, 2007

(54) Removable digital audio recording interface device

(75) Inventors: Anthony Rodrigues, Manteca, CA (US); Samuel Luna, Snohomish, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: LOUD Technologies Inc., Woodinville, WA (US)

(21) Appl. No.: 11/444,147

(22) Filed: May 30, 2006

(51) Int. Cl. G05B 15/00

(52) U.S. Cl. 700/83

(57) ABSTRACT

A digital recording interface device is provided, which consists of a base unit and a remote unit that are removably coupled to each other. The base unit includes one or more input connections configured to be coupled to one or more external analog audio sources, such as microphones, musical instruments, mixers, amplifiers, etc. The base unit also includes one or more output connections configured to be coupled to one or more external audio output devices, such as speakers, headphones, etc. Typically, the base unit remains connected to various audio sources and audio output devices. The remote unit includes analog-digital conversion circuitry that converts analog audio received from the base unit to digital audio, and digital transmission circuitry that transmits the digital audio along a digital transport interface to an external digital computing device, in which the digital audio can be recorded or otherwise processed. Once a digital recording/processing session is completed, the user can remove the remote unit from the base unit.

### FIELD OF THE INVENTION

The present invention relates generally to an audio system and, more specifically, to a digital recording interface device that permits recording analog audio signals in a digital computing device such as a laptop computer.

### BACKGROUND OF THE INVENTION

Digital audio recording interface devices, or digital recording interface devices, have been used to record high-quality audio from various audio sources (e.g., electric guitars, keyboards, vocal microphones, etc.) to digital computing devices (e.g., personal computers). The advent and popularity of portable computing devices (e.g., laptop computers) have led to many users taking their digital recording environments (e.g., the combinations of their laptop computers and digital recording interface devices) into the field, where various audio sources are located. One problem with field recording is that a user must first disconnect from his digital recording interface device a significant number of cables leading to a set of audio sources and audio output devices located in a studio and, then, upon arriving at the field, must connect to the digital recording interface device a significant number of cables leading to another set of audio sources and audio output devices located at the field. For example, referring to FIG. 1, the user's digital recording environment generally consists of a digital computing device 10 and a digital recording interface device 12. To the digital recording interface device 12, a number of cables are connected leading to speakers 14, microphones 16, other audio devices (e.g., electric guitars) 18, and power sources 19. Having to disconnect and connect all these cables, each time the user wishes to move to a different recording site, is quite cumbersome for the user.

### SUMMARY OF THE INVENTION

To address the above-described problem and to additionally offer various functional advantages, the present invention offers a digital recording interface device that consists of a base unit and a remote unit, which are removably coupled with each other. In one embodiment, the base unit (BU) includes one or more input connections configured to be connected to one or more external audio sources, such as microphones, musical instruments, analog amplifiers, analog mixers, etc. The base unit also includes one or more output connections configured to be connected to one or more external audio output devices, such as speakers, headphones, etc. In typical use, the base unit may remain connected to various audio sources and audio output devices. The remote unit (RU) includes analog-digital conversion circuitry that converts analog audio received from the base unit to digital audio, and digital transmission circuitry that transmits the digital audio along a digital transport interface to an external digital computing device, in which the digital audio can be recorded or otherwise processed. Once a digital recording/processing session is completed, the user can remove the remote unit from the base unit, to which various audio sources and audio output devices remain connected. Then, the user can carry the remote unit to a different site and connect the remote unit to a different base unit, to which various audio sources and audio output devices are also connected, to start a new digital recording/processing session.

In accordance with one aspect of the invention, the base unit may also include analog-digital conversion circuitry that converts digital signals to analog audio. Also, the analog-digital conversion circuitry of the remote unit may be further configured to convert digital signals to analog audio. Thus, the base unit and the remote unit may each convert the digital signals from the digital transmission circuitry of the remote unit into analog audio to be output via audio output devices.

In accordance with another aspect of the invention, the remote unit and the base unit are removably coupled via a multi-pin connector, which provides various functionalities such as analog audio transmission, digital data transmission, power supply, connection detection, and ground connection. In accordance with a further aspect of the invention, a multi-pin connector may be used for the remote unit to supply power to the base unit or for the base unit to supply power to the remote unit. In accordance with a still further aspect of the invention, coupling of the remote unit and the base unit may be facilitated by a physical alignment mechanism and a locking mechanism.

In accordance with yet another aspect of the invention, audio and/or control information may be transmitted between the base unit and the remote unit based on various signal/data transmission technologies, such as a radio frequency signal-based technology, optical technology, infrared technology, and inductive technology.

In accordance with a further aspect of the invention, each of the remote unit and the base unit is configured to be capable of functioning independent of one another. To this end, for example, the remote unit may include at least one input connection configured to be connected to an external audio source and at least one output connection configured to be connected to an external audio output device. Then, to the remote unit (disconnected from the base unit), external audio sources such as analog amplifiers, analog mixers, microphones, and musical instruments, may be connected, to permit digital recording of the analog audio from these sources in a digital computing device. Also, to the remote unit, external audio output devices, such as headphones, may be connected to permit a user to monitor the digital signals as being recorded in the digital computing device. The base unit may likewise be configured to function independently of the remote unit, for example as an analog audio processing device such as an audio mixer, audio amplifier, passive speaker, amplified speaker, signal processor, or any combination thereof. As further examples, the base unit may also be configured to function independently of the remote unit as any of a music/piano-type keyboard, drum or percussion trigger devices, a guitar or wind instrument, and any combination thereof.

In accordance with another aspect of the invention, the digital transmission circuitry included in the remote unit to transmit digital audio to an external digital computing device is an IEEE 1394 device, such as a FireWire interface device

In accordance with a different aspect of the invention, the remote unit further includes one or more preamplifiers that can be coupled to the one or more input connections connected to external audio sources. In accordance with another aspect of the invention, the remote unit may also include one or more level metering devices (e.g., dBFS metering devices) along one or more channels connected to the one or more external audio sources, respectively. The preamplifiers and/or level metering devices permit a user to control input and output levels of the digital recording interface device and hence the digital recording levels in a digital computing device.

In accordance with another embodiment of the present invention, a digital recording interface device is provided including a base unit and a remote unit that is removably coupled to the base unit. The base unit includes at least one input connection configured to be connected to an external audio source and at least one output connection configured to be connected to an external audio output device. The remote unit includes analog-digital conversion circuitry that converts analog audio to a digital signal, and digital transmission circuitry that transmits the digital signal along a digital transport interface to an external digital computing device. The digital recording interface device further includes a user interface control including at least one analog control for controlling a level of the analog audio in the remote unit (e.g., based on a preamplifier arranged along each audio channel in the remote unit). According to one aspect of the present invention, the user interface control may further include at least one digital control for controlling a level of the digital signal in the remote unit.

Further embodiments of the present invention include a remote unit for use in a digital recording interface device, and a base unit for use in a digital recording interface device.

As will be appreciated from the foregoing, a truly portable digital audio recording environment can be achieved by the use of a digital recording interface device formed in accordance with the present invention. Users of the digital recording interface devices according to the present invention can readily disconnect/connect their remote units from/to their base units, to move from one digital audio recording site to another.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates an arrangement in which a conventional digital recording interface device is used to convert analog signals from various audio sources to digital format for recording in a digital computing device;

FIG. 2 illustrates an arrangement in which a digital recording interface device according to one embodiment of the present invention is used to convert analog signals from various audio sources to digital format for recording in a digital computing device;

FIG. 3 is a block functional diagram of the digital recording interface device of FIG. 2 and other devices surrounding the digital recording interface device;

FIG. 4A is a top view of a digital recording interface device according to one embodiment of the present invention, including a remote unit and a base unit;

FIG. 4B is a side view of the digital recording interface device of FIG. 4A;

FIG. 4C is a rear view of the digital recording interface device of FIG. 4A;

FIG. 5 is a top view of the base unit of the digital recording interface device of FIG. 4A, from which the remote unit has been removed;

FIG. 6A is a top view of the remote unit of the digital recording interface device of FIG. 4A, which has been removed from the base unit;

FIG. 6B is a bottom view of the remote unit of FIG. 6A, which has been removed from the base unit;

FIGS. 7A and 7B jointly represent a sample circuit diagram suitable for forming a digital recording interface device according to one embodiment of the present invention; and

FIGS. 8A and 8B are schematic partial cross-sectional views of a digital recording interface device, including a locking mechanism for securing a remote unit to a base unit.

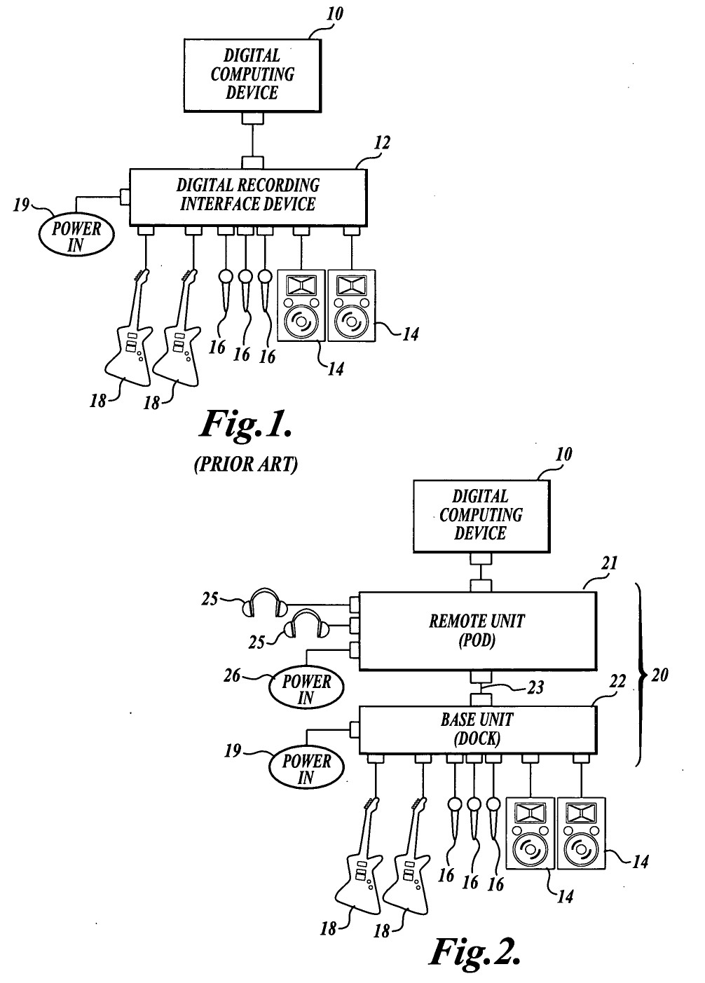

### DETAILED DESCRIPTION OF THE PREFERRED EMBODIMENT

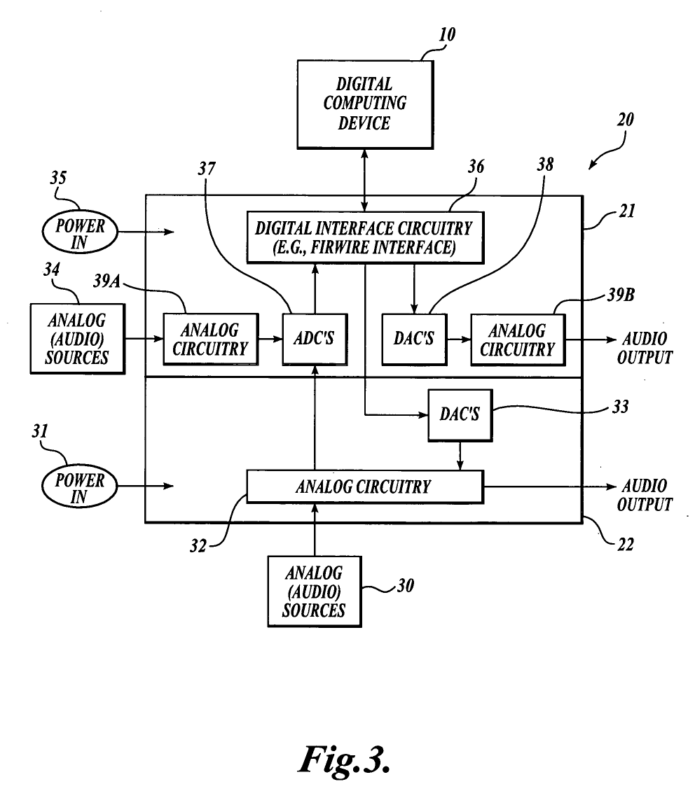

FIG. 2 illustrates an arrangement in which a digital recording interface device 20 according to one embodiment of the present invention is used to convert analog signals from various audio sources to digital format for recording in a digital computing device 10, such as a laptop or desktop PC or Macintosh (MAC) computer. It should be understood that the digital computing device 10 may be any computing device having digital audio recording/processing functionality, and thus is not limited to a PC or MAC computer. In various exemplary embodiments of the present invention, the digital computing device 10 may be a digital audio workstation (DAW), which is a computer specifically equipped with a high-quality sound card and programming for editing and processing digital audio at a professional level.

The digital recording interface device 20 includes a remote unit (POD) 21 and a base unit (DOCK) 22, which are removably connectable with each other via, for example, a multi-pin electrical connector 23. The digital recording interface device 20 (or the remote unit 21) is coupled with the digital computing device 10 via, for example, IEEE 1394a (FireWire) connection, as will be more fully described below.

The base unit 22 includes a number of input connections to which are connected various audio sources, such as microphones 16 and electric guitars 18, and power source(s) 19. In some embodiments or arrangements, the base unit 22 may be powered by the power source(s) 19, while in other embodiments or arrangements the base unit 22 may be powered by the remote unit 21 via the (multi-pin) connector 23. The base unit 22 also includes one or more output connections to which audio output devices, such as speakers 14, are connected. In typical use, the base unit 22 is intended to remain connected to these audio sources, power source(s), and audio output devices.

The remote unit 21 includes analog-digital conversion circuitry that converts analog audio received from external audio sources (e.g., via the base unit 22) to digital signals. The remote unit 21 also includes digital transmission circuitry for transmitting the digital signals along a digital transport interface to the digital computing device 10. In one embodiment, the remote unit 21 further includes analog circuitry and one or more input connections and output connections, to which audio sources (not shown) and audio output devices, such as headphones 25, can be connected. The remote unit 21 also includes an input connection to power source(s) 26.

In some embodiments or arrangements, the remote unit 21 may be powered by the power source(s) 26, while in other embodiments or arrangements the remote unit 21 may be powered by the base unit 22 via the connector 23. In further embodiments or arrangements, the remote unit 21 (and in some cases also the base unit 22) may be powered by the digital computing device 10.

In typical use, the remote unit 21 is coupled with the digital computing device 10 and the base unit 22, to which various audio sources and audio output devices are connected, to allow digital recording of analog audio. Once a digital recording session is over, the user can disconnect the remote unit 21 from the base unit 22. The user then carries the remote unit 21, perhaps together with the digital computing device 10, to a different recording site and plug it onto a different base unit, to which a different set of audio sources and audio output devices are connected.

In some embodiments of the present invention, the remote unit 21 may be configured to also function as a stand-alone digital recording interface device without the base unit 22. For example, the remote unit 21 may include one or more input connections, to which various audio sources, such as analog amplifiers, analog mixers, analog signal processors, microphones, and electric musical instruments, may be connected. Then, the remote unit 21 alone, together with the digital computing device 10, can be used to carry out digital recording/processing of analog audio from these audio sources. In other words, the remote unit 21 used in this manner provides digital recording/processing capabilities to these analog sources.

Likewise, the base unit 22 may also be configured to function independently of the remote unit 21. For example, the base unit 22 may be or include an analog amplifier, analog mixer, passive speaker, amplified speaker, signal processor, or any combination thereof, such that the base unit 22, even without the remote unit 21, can still function as any of these analog devices. As further examples, the base unit 22 may also be configured to function independently of the remote unit as any of a music/piano-type keyboard, drum or percussion trigger devices, a guitar or wind instrument, and any combination thereof.

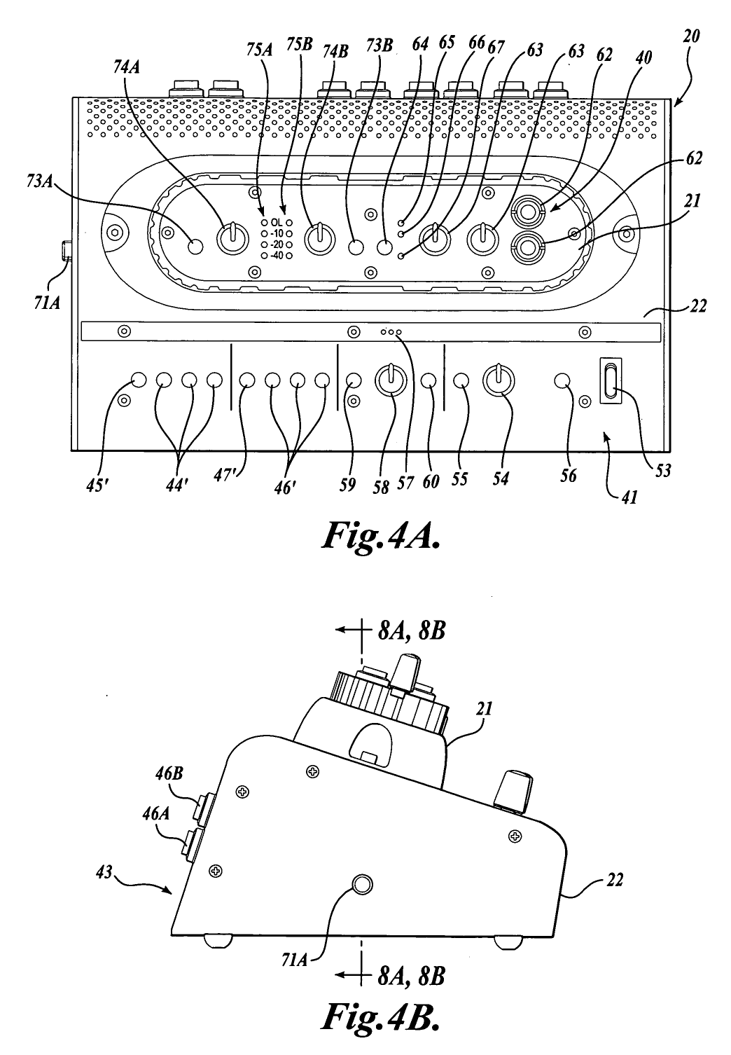

Referring to FIG. 3, the configuration and functionality of the digital recording interface device 20 according to one embodiment of the present invention are described. The digital recording interface device 20 generally consists of the remote unit 21 and the base unit 22. To the base unit 22, a plurality of analog audio sources 30 (e.g., microphones, electric musical instruments, etc.) are connected, as described above. The base unit 22 may also include a connection to a power source 31. The base unit 22 generally includes analog circuitry 32 and analog-digital conversion circuitry including one or more digital-to-analog converters (DAC's) 33. The analog circuitry 32 processes a plurality of audio channels coming from the analog audio sources 30 and forwards them to the remote unit 21. The DAC's 33 convert digital signals received from the remote unit 21 to analog signals and forward the analog signals to the analog circuitry 32, which then processes and outputs the received analog signals as audio output via, for example, speakers and headphones.

To the remote unit 21, one or more analog audio sources 34 may be connected. The remote unit 21 may also include a connection to a power source 35. When the remote unit 21 is connected with the base unit 22, the remote unit 21 may be powered by the base unit 22, which in turn is powered by the power source 31. Alternatively, the base unit 22 may be powered by the remote unit 21, which in turn is powered by the power source 35. The remote unit 21 generally includes digital interface circuitry 36, analog-digital conversion circuitry including one or more analog-to-digital converters (ADC's) 37 and one or more digital-to-analog converters (DAC's) 38, and analog circuitry 39A and 39B. The analog circuitry 39A processes analog signals coming from the audio sources 34 and forwards them to the ADC's 37, which convert the analog signals to digital signals and forward the digital signals to the digital interface circuitry 36. The ADC's 37 also convert analog signals received from the analog circuitry 32 of the base unit 22 to digital signals and forward the digital signals to the digital interface circuitry 36. The digital interface circuitry 36 is coupled with the digital computing device 10.

The digital interface circuitry 36 in accordance with various exemplary embodiments of the present invention is provided in the form of a FireWire interface device. Specifically, the digital audio from the ADCs 37 may be sent to the digital computing device 10 along a digital transport system provided in the form of IEEE 1394 FireWire interface device 36. As well known in the art, IEEE 1394 is a very fast external bus standard, and various products supporting the 1394 standard are available under the trademarks such as FireWire, i.link, Lynx, High Performance Serial Bus (HPSB), etc. Accordingly, as used herein, “IEEE 1394 device” refers to any bus device that supports the high speed data transfer as defined under the 1394 standard. Alternatively, the FireWire interface device 36 (or any IEEE 1394 device) can be replaced with other types of high-speed data interface systems, such as an interface utilizing USB 2.0 technology or an interface utilizing any other high-speed data interface system that is currently available or to be developed in the future.

The DAC's 38 in the remote unit 21 convert digital signals received from the digital interface circuitry 36 to analog signals and forward the analog signals to the analog circuitry 39B within the remote unit 21, which processes and outputs the received analog signals as audio output via, for example, speakers and headphones.

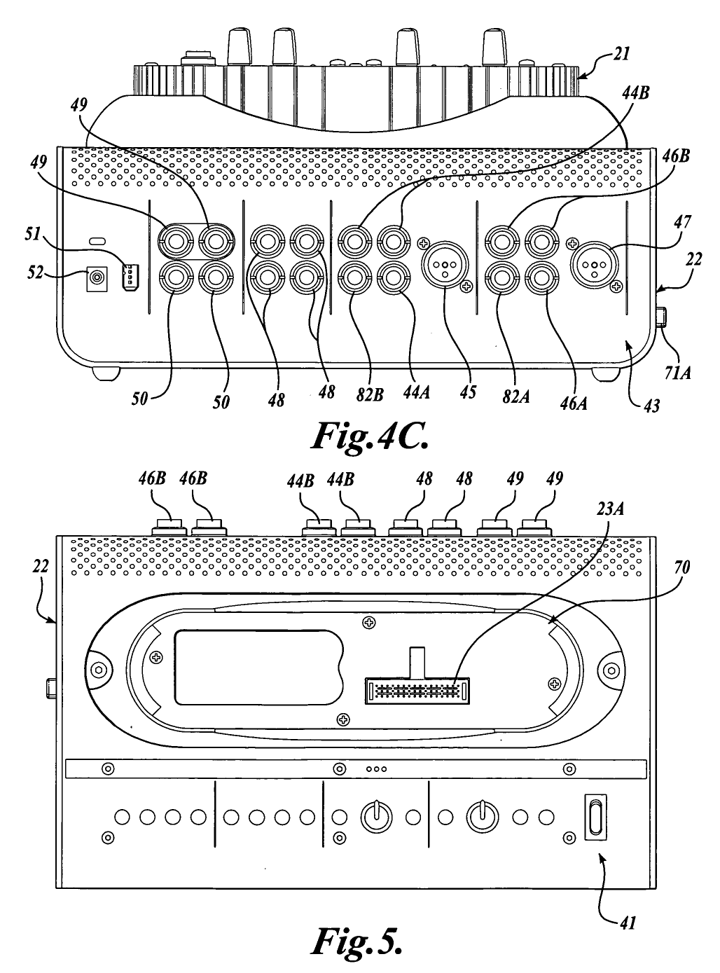

FIGS. 4A-4C illustrate one embodiment of a digital recording interface device 20, including a remote unit 21 and a base unit 22 that are removably connected with each other. Referring specifically to FIG. 4A, a top (or front) panel of the digital recording interface device 20 includes a top (or front) panel 40 of the remote unit 21 and a top (or front) panel 41 of the base unit 22, each including various controls and indicators, as will be more fully described below.

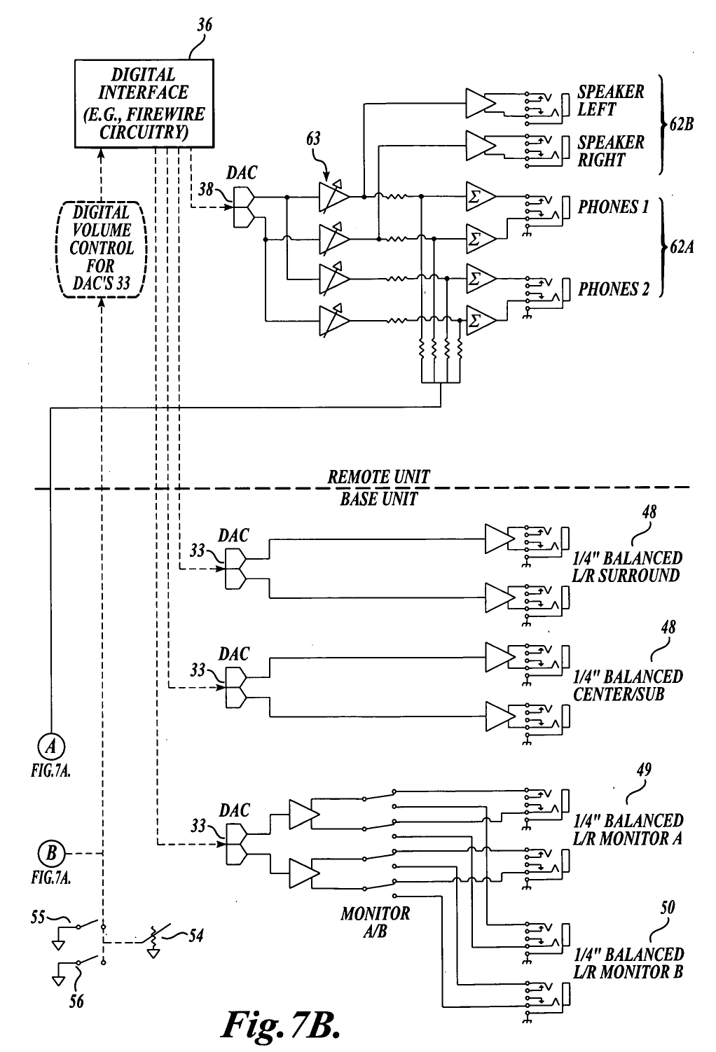

Referring to FIGS. 4B and 4C, a rear panel 43 of the base unit 22 includes a number of input/output connections. Referring additionally to FIG. 7 (consisting of FIGS. 7A and 7B), which is a sample circuit diagram generally corresponding to the embodiment of the digital recording interface device depicted in FIGS. 4A-4C, the rear panel 43 in the illustrated embodiment includes a first set (e.g., Channel 1) of input connections, including a high impedance input connection 44A, line input connections 44B, and a microphone input connection 45. The rear panel 43 also includes a second set (e.g., Channel 2) of input connections, including a high impedance input connection 46A, line input connections 46B, and a microphone input connection 47. To these input connections, various analog audio sources can be connected, such as microphones, musical instruments, analog audio amplifiers, analog audio mixers, signal processors, etc.

The rear panel 43 further includes a set of analog output connections 48 (four such connections are shown), to which audio output devices such as speakers and headphones can be connected. In the illustrated embodiment, the rear panel 43 still further includes a set of “control room” output connections 49 and 50, to which audio output devices such as studio monitor speakers or headphones typically for use in a control room can be connected. The monitor speakers or headphones may be used to monitor the digital signals as being recorded in the digital computing device 10. The rear panel 43 also includes a digital interface port, such as a FireWire port 51, and a power connection 52. The digital interface port 51 is used to couple the digital recording interface device 20 to a digital computing device 10, in which digital audio signals can be processed and recorded.

Referring specifically to FIG. 7A, a pair of channel insert connections 82A and 82B may be included in the base unit 22. As illustrated, the channel insert points may be directly after preamplifiers 74A and 74B included in the remote unit 21. As well known in the art, an insert send sends signals to an external unit, such as a compressor or equalizer, and an insert return accepts the output from the external unit. The channel insert connections 82A and 82B may be provided in the form of a stereo jack socket (3-pole jack), in which the tip connection provides the insert send and the ring connection provides the insert return. Referring additionally to FIG. 4C, the base unit 22 may include channel insert connections 82A and 82B in the form of jack sockets.

Referring back to FIG. 4A, the top panel 41 of the base unit 22 includes a first set (e.g., Channel 1) of switches 44′ and 45′ associated with the analog signals coming via the high impedance/line input connections 44A and 44B and the microphone input connection 45, respectively. The top panel 41 also includes a second set (e.g., Channel 2) of switches 46′ and 47′ associated with the analog signals coming via the high impedance/line input connections 46A and 46B and the microphone input connection 47, respectively. These switches 44′, 45′, 46′, and 47′ are used to select and mix analog signals coming from the input connections 44, 45, 46, and 47 coupled to various analog audio sources.

The top panel 41 also includes a set of “control room” switches and controls, including a power switch 53, a volume level control knob 54, a DAW (digital audio workstation) bypass switch 55, and a fixed/variable level control switch 56. (In FIGS. 7A and 7B, the flow of control logic signal is indicated in broken lines, such as those lines extending from the volume level control knob 54, the DAW bypass switch 55, and the fixed/variable level control switch 56.) The volume level control knob 54 controls the volume level of DAC's 33 included in the base unit 22 (see also FIG. 3) and hence the volume level of the analog output connections 48 and/or the control room output connections 49 and 50. The DAW bypass switch 55 can be used to disengage the DAW (the digital computing device 10) from the digital recording interface device 20, even when the DAW may be physically coupled to the digital recording interface device 20, so that digital signals can pass through the digital recording interface device 20 without being routed to the DAW. The fixed/variable (6-way) level control switch 56 allows for the base unit's analog audio output to be either a fixed level output or a variable output. In the variable output mode, the volume level control knob 54 affects the analog output level of each of the various output connections (channels/jacks). In the fixed level output mode, the volume level control knob 54 has no effect, allowing the user to calibrate his monitoring environment to a specific audio output standard (0 dBFS, THX monitor settings, etc.).

The top panel 41 of the base unit 22 further includes a talkback microphone 57 embedded in the top panel 41, a talkback microphone volume level control knob 58, a switch to talkback to headphones 59, and a switch to talkback to DAW 60. The talkback microphone 57 is used to permit communication between, for example, an artist and an audio engineer. The talkback microphone volume level control knob 58 controls the volume level of the talkback microphone 57. The switch to talkback to headphones 59 couples the analog audio from the talkback microphone 57 to one or more sets of headphones (or speakers) coupled to the remote unit 21, as will be described below. On the other hand, the switch to talkback to DAW 60 couples the analog audio from the talkback microphone 57 to the DAW (or the digital computing device 10).

The top panel 40 of the remote unit 21 includes a pair of audio outputs 62, to which two sets of headphones 62A (see FIG. 7B) may be connected, respectively. The audio outputs 62 may be alternatively or additionally used to drive two (left and right) speakers 62B. The top panel 40 also includes audio (e.g., headphone) level control knobs 63 for controlling the volume levels of the audio outputs 62, respectively. When the switch to talkback to headphones 59 in the top panel 41 of the base unit 22 is activated, the analog audio from the talkback microphone 57 is routed to the audio outputs 62, to which the headphones 62A (and/or the speakers 62B) may be connected.

The top panel 40 of the remote unit 21 also includes a power switch 64, a power indicator 65, a digital interface connection indicator 66, and a docking indicator 67. The power indicator 65 indicates whether power is on. The digital interface connection indicator 66 indicates whether the remote unit 21, either alone or in combination with the base unit 22, is coupled via a digital interface port, such as a FireWire port, to a digital computing device 10. The docking indicator 67 indicates whether the remote unit 21 is docked to, or is connected to, the base unit 22.

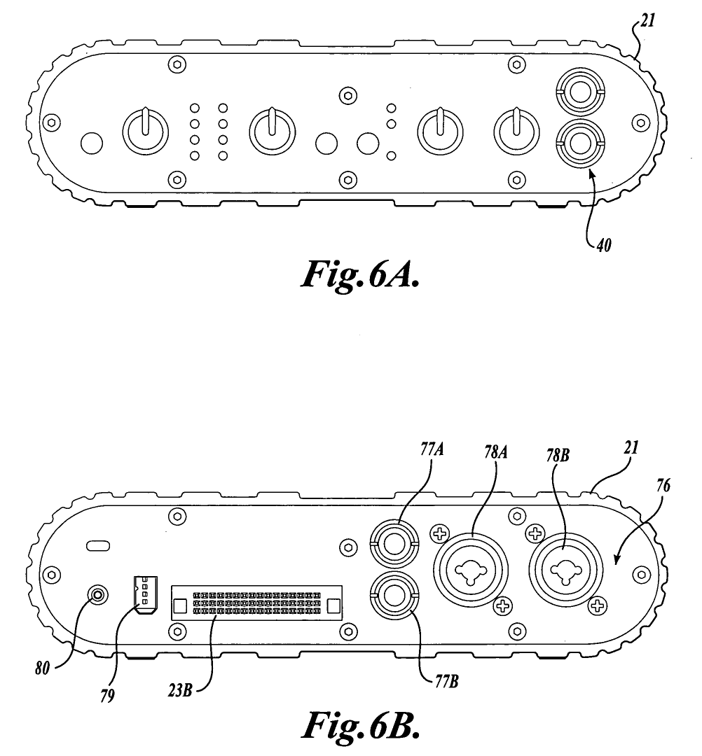

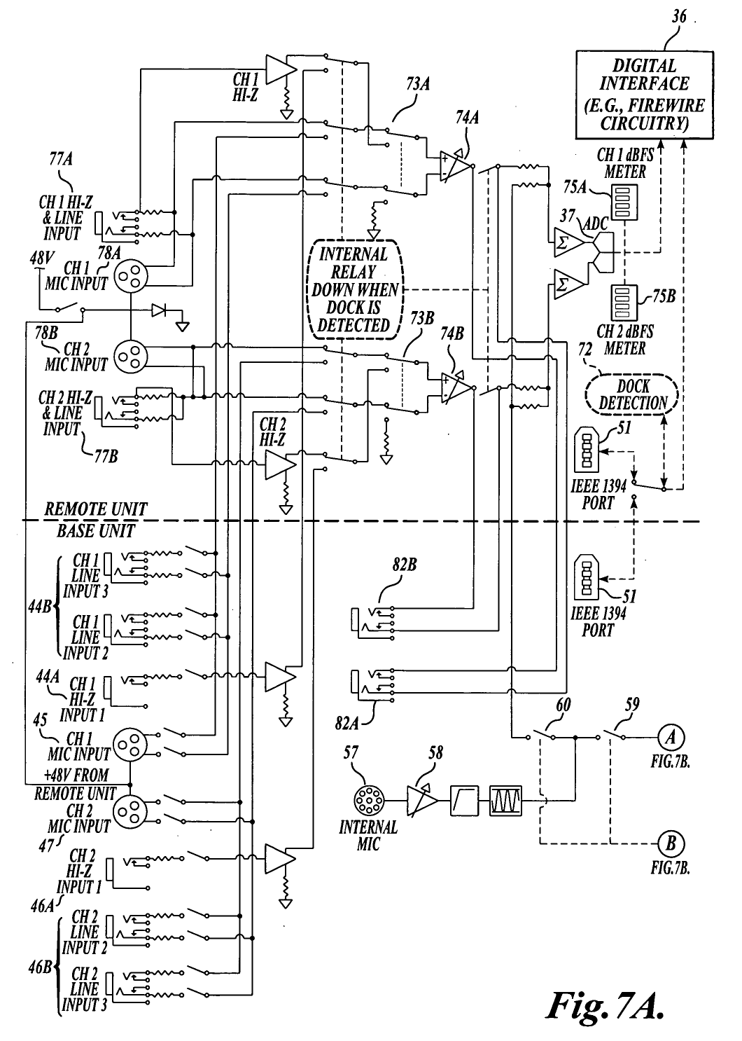

Referring additionally to FIG. 5 that shows the base unit 22 without the remote unit 21, and to FIG. 6B showing a bottom (or rear) panel 76 of the remote unit 21, the docking of the remote unit 21 to the base unit 22 may be carried out by mating multi-pin electrical connector parts 23A and 23B provided in the base unit 22 and the remote unit 21, respectively. The use of a multi-pin connector is advantageous because it provides various functionalities such as analog audio transmission, digital data transmission, power supply, and ground connection between the remote unit 21 and the base unit 22. Further, one or more pins in a multi-pin connector may be used to detect whether the remote unit 21 is connected to (or docked to) the base unit 22. Detection of a docking state (72 in FIG. 7A) is used as part of the flow of control logic signal in the digital recording interface device 20.

In accordance with various exemplary embodiments of the present invention, the result of docking detection may affect some of the functionality of the remote unit 21. For example, the remote unit 21 may be configured such that, when the docking status is detected, it processes analog audio signals received from the base unit 22, while when the docking status is not detected it processes analog audio signals input to the remote unit 21 directly from external analog audio sources (e.g., via connections 77A-78B in FIG. 7A).

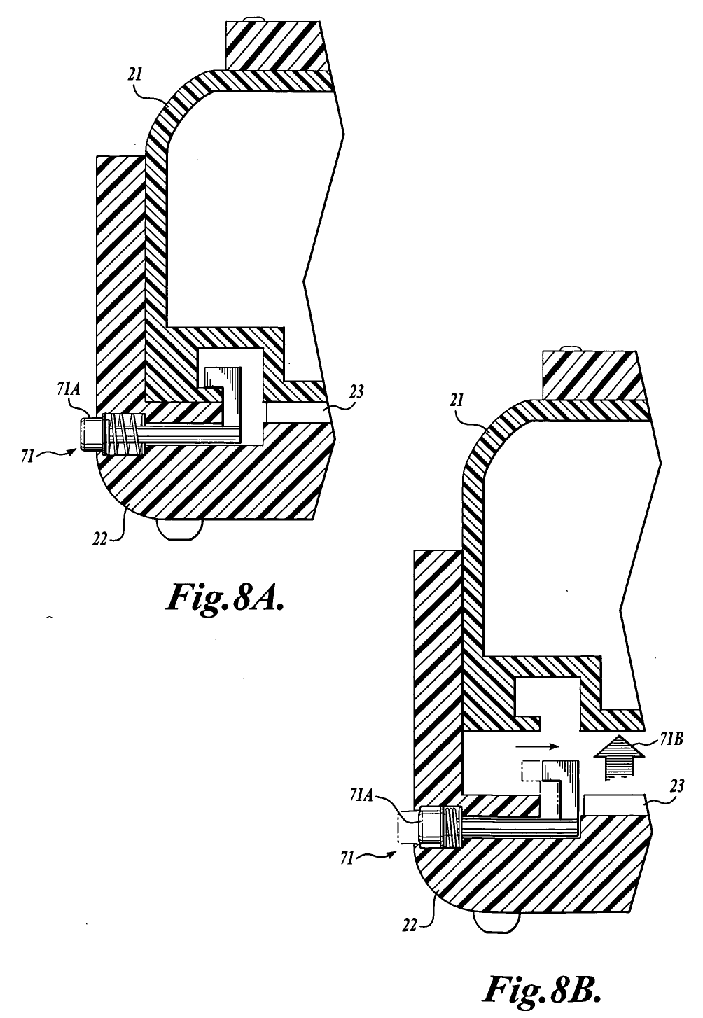

To ease the docking operation, a physical alignment mechanism may be provided, for example in the form of an indented area 70 defined in the top panel 41 of the base unit 22, which is sized and shaped to snugly receive the bottom (or rear) portion of the remote unit 21. Further, a suitable locking (or lock-and-release) mechanism, such as a locking mechanism 71 with a push button 71A shown in FIGS. 4B, 8A, and 8B, may be provided to secure the connection between the remote unit 21 and the base unit 22. FIG. 8A is a schematic partial cross-sectional view taken from FIG. 4B, and illustrates an embodiment of the locking mechanism 71 provided in the form of a spring-loaded latch arranged within the base unit 22 to secure the remove unit 21 when it is docked. As shown in FIG. 8B, when the push button 71A is pressed to compress (load) the spring, the locking mechanism 71 releases the remote unit 21, which can then be moved upward, as indicated by an arrow 71B, to be removed from the base unit 22. Various configurations and arrangements of physical alignment and locking mechanisms should be apparent to one skilled in the art. For example, a locking mechanism 71 may be operated electrically, as opposed to mechanically as illustrated in FIGS. 8A and 8B.

Referring back to FIGS. 4A and 7A-B, the top panel 40 of the remote unit 21 may also include a Mic-Line/Hi-Z (microphone-line level/high impedance) switch 73A for Channel 1, which toggles between receiving analog audio signals either from any of the line input connections 44B and the microphone input connection 45 or from the high impedance input connection 44A. Likewise, a Mic-Line/Hi-Z switch 73B for Channel 2 is provided, which toggles between receiving analog audio signals either from any of the line input connections 46B and the microphone input connection 47 or from the high impedance input connection 46A. Thus, these switches 73A and 73B, in addition to the switches 44′, 45′, 46′, and 47′ provided on the base unit 22 described above, can be used to select and mix analog signals coming from various external audio sources.

The top panel 40 of the remote unit 21 may further include a pair of preamplifier gain control knobs 74A and 74B for controlling the gain of analog audio signals coming from Channel 1 (including the input connections 44 and 45) and Channel 2 (including the input connections 46 and 47) of the base unit 22, respectively. The gain-controllable preamplifiers 74A and 74B in the remote unit 21 (see FIG. 7A) permit a user to control analog input levels in the remote unit 21 and hence the digital output levels from the remote unit 21.

Finally, the top panel 40 of the remote unit 21 may include level meters 75A and 75B (after the analog-to-digital converters, or ADC's 37, in FIG. 7A). The level meters 75A and 75B indicate digital levels of Channels 1 and 2, respectively, for example in terms of dBFS (Decibel Below Full Scale). In the illustrated embodiment, the level meters 75 meter digital signals in four dBFS levels: 0, −10, −20, and −40 dBFS.

Referring specifically to FIGS. 7A and 7B, in one example, the digital interface circuitry 36 (shown twice in both FIGS. 7A and 7B) may be provided in the form of FireWire circuitry, such as OXFW970 FireWire controller chip including 18 channel out and 2 channel in, available from Oxford Semiconductor. The analog-to-digital converters (ADC's) 37 and the digital-to-analog converters (DAC's) 38 as included in the remote unit 21 may be provided in the form of AK4528 or equivalent, available from AKM Semiconductor or other mixed-signal semiconductor company, which contains 2 ADCs (37) and 2 DACs (38). The digital-to-analog converters (DAC's) 33 in the base unit 22 may be provided in the form of AK4358 or equivalent, also available from AKM Semiconductor or other mixed-signal semiconductor company.

Referring additionally to FIG. 6B, the functionality of the remote unit 21 when it is used as a stand-alone device without the base unit 22 is described in detail. The bottom (or rear) panel 76 of the remote unit 21 includes a first set (e.g., Channel 1) of input connections, including a high impedance and line input connection 77A and a microphone input connection 78A (with XLR phantom power adapter). The bottom (or rear) panel 76 of the remote unit 21 also includes a second set (e.g., Channel 2) of input connections, including a high impedance and line input connection 77B and a microphone input connection 78B (with XLR phantom power adapter). When the docking status between the remote unit 21 and the base unit 22 is not detected (e.g., based on the use of a multi-pin connector 23), the digital interface circuitry 36 receives analog audio signals from the first and second sets of input connections 77A, 78A, 77B, and 78B of the remote unit 21 via the Mic-Line/Hi-Z switches 73A and 73B and the gain controllable preamplifiers 74A and 74B, as opposed to from the base unit 22. The bottom (or rear) panel 76 of the remote unit 21 includes a digital interface port 79, such as a FireWire port, and a power connector 80. The digital interface port 79 is used to couple the remote unit 21 directly to a digital computing device 10 when the remote unit 21 is used without the base unit 22.

It should be understood that the configuration and arrangement of the digital recording interface device 20 as depicted in FIGS. 4A-6B and the corresponding circuitry as depicted in FIGS. 7A and 7B represent one example of an embodiment of the present invention. Various modifications to the depicted embodiment are possible, as will be apparent to one skilled in the art. For example, the number and types of inputs and outputs provided in the remote unit 21 and/or the base unit 22 may change depending on a particular application. As a specific example, the remote unit 21 and/or the base unit 22 may be configured to receive not only analog audio signals but also digital signals from external sources, such as from digital audio devices and digital musical instruments, if such functionality is desired. It should also be understood that a digital recording interface device and its circuitry formed in accordance with the present invention may include additional components, devices, and elements, which are not explicitly depicted in FIGS. 4A-7 for the purpose of brevity and clarity only. It should further be understood that transmission of audio signal and/or control information between the remote unit 21 and the base unit 22 may be based on various data/control transmission technologies and protocols, such as a radio frequency signal-based technology, optical technology, infrared-based technology, and inductive technology.

According to various exemplary embodiments, the present invention also offers a remote unit for use in a digital recording interface device as described above, and a base unit for use in a digital recording interface device as described above.

While the preferred embodiments of the invention have been illustrated and described, it will be appreciated that various changes can be made therein without departing from the spirit and scope of the invention.

1. A digital recording interface device comprising:
a base unit comprising at least one input connection configured to be connected to an external audio source and at least one output connection configured to be connected to an external audio output device; and
a remote unit removably coupled to the base unit, the remote unit comprising analog-digital conversion circuitry that converts analog audio to digital audio and digital transmission circuitry that transmits the digital audio along a digital transport interface to an external digital computing device.

2. The digital recording interface device of claim 1, wherein the base unit further comprises analog-digital conversion circuitry that converts digital audio to analog audio.

3. The digital recording interface device of claim 1, wherein the analog-digital conversion circuitry of the remote unit is further configured to convert digital audio to analog audio.

4. The digital recording interface device of claim 1, wherein the remote unit and the base unit are removably coupled via a multi-pin connector that provides for one or more of analog audio transmission, digital data transmission, power supply, connection detection, and ground connection.

5. The digital recording interface device of claim 1, wherein the remote unit is configured to supply power to the base unit.

6. The digital recording interface device of claim 1, wherein the base unit is configured to supply power to the remote unit.

7. The digital recording interface device of claim 1, wherein audio and/or control information is transmitted between the base unit and the remote unit based on a data transmission technology selected from a group consisting of a radio frequency signal-based technology, optical technology, infrared technology, and inductive technology.

8. The digital recording interface device of claim 1, further comprising a physical alignment mechanism that is configured to facilitate alignment of the remote unit and the base unit when they are to be removably coupled.

9. The digital recording interface device of claim 1, further comprising a locking mechanism that is configured to secure coupling between the remote unit and the base unit.

10. The digital recording interface device of claim 1, wherein the remote unit further comprises at least one input connection configured to be connected to an external audio source.

11. The digital recording interface device of claim 10, wherein the external audio source is selected from a group consisting of an analog amplifier, an analog mixer, and an analog signal processor.

12. The digital recording interface device of claim 10, wherein the external audio source is selected from a group consisting of a microphone and a musical instrument.

13. The digital recording interface device of claim 1, wherein the remote unit further comprises at least one output connection configured to be connected to an external audio output device.

14. The digital recording interface device of claim 13, wherein the external audio output device is selected from a group consisting of a speaker and a set of headphones.

15. The digital recording interface device of claim 1, wherein the remote unit further comprises at least one preamplifier arranged to be coupled to the at least one input connection of the base unit.

16. The digital recording interface device of claim 1, wherein the remote unit further comprises at least one level metering device arranged to be coupled to the at least one input connection of the base unit.

17. The digital recording interface device of claim 1, wherein the digital transmission circuitry of the remote unit comprises an IEEE 1394 device.

18. The digital recording interface device of claim 1, wherein the base unit comprises a device selected from a group consisting of an audio mixer, an audio amplifier, a passive speaker, an amplified speaker, an audio signal processor, and any combination thereof.

19. The digital recording interface device of claim 1, wherein the base unit comprises a device selected from a group consisting of a music/piano-type keyboard, drum or percussion trigger devices, a guitar or wind instrument, and any combination thereof.

20. A digital recording interface device comprising:
a base unit comprising at least one input connection configured to be connected to an external audio source and at least one output connection configured to be connected to an external audio output device;
a remote unit removably coupled to the base unit, the remote unit comprising analog-digital conversion circuitry that converts analog audio to a digital signal and digital transmission circuitry that transmits the digital signal along a digital transport interface to an external digital computing device; and
a user interface control comprising at least one analog control for controlling a level of the analog audio in the remote unit.

21. The digital recording interface device of claim 20, wherein the user interface control further comprises at least one digital control for controlling a level of the digital signal in the remote unit.

22. A base unit for use in a digital recording interface device, the digital recording interface device including a remote unit comprising analog-digital conversion circuitry that converts analog audio to digital audio and digital transmission circuitry that transmits the digital audio along a digital transport interface to an external digital computing device, the base unit comprising:
at least one input connection configured to be connected to an external audio source; and
at least one output connection configured to be connected to an external audio output device,
wherein the base unit is configured to be removably coupled to the remote unit.

23. A remote unit for use in a digital recording interface device, the digital recording interface device including a base unit comprising at least one input connection configured to be connected to an external audio source and at least one output connection configured to be connected to an external audio output device, the remote unit comprising:
analog-digital conversion circuitry that converts analog audio to digital audio; and
digital transmission circuitry that transmits the digital audio along a digital transport interface to an external digital computing device,
wherein the remote unit is configured to be removably coupled to the base unit.
